(19) United States
(12) Patent Application Publication
(10) Pub. No.: US 2026/0179633 A1
(43) Pub. Date: Jun. 25, 2026

(54) NOISE CANCELLING APPARATUS, NOISE CANCELLING METHOD, AND PROGRAM

(71) Applicant: NTT, Inc., Tokyo (JP)

(72) Inventors: Hiroaki ITO, Tokyo (JP); Yohei WAKISAKA, Tokyo (JP); Noriyoshi KAMADO, Tokyo (JP); Shin MURATA, Tokyo (JP)

(73) Assignee: NTT, Inc., Tokyo (JP)

(21) Appl. No.: 18/719,448

(22) PCT Filed: Dec. 21, 2021
(86) PCT No.: PCT/JP2021/047261

§ 371 Date: Jun. 13, 2024

(51) Int. Cl. G10L 21/0208; G10K 11/178; G10L 21/0232

(52) U.S. Cl. CPC G10L 21/0208; G10K 11/17823; G10L 21/0232; G10K 2210/3028; G10L 2021/02082

(57) ABSTRACT

A noise suppression technique which operates stably even when a reference microphone or an error microphone picks up sound other than noise assumed to occur around a user is provided. A noise suppression device suppresses a noise suppression function for sounds other than noise expected to occur around the user.

### TECHNICAL FIELD

The present invention relates to an active noise control technique.

### BACKGROUND ART

An active noise control technique is a technique which suppresses noise at specific locations such as a user's surroundings and is incorporated into vehicles, for example, to suppress sounds from the outside of the vehicle so that the user can hear desired sounds such as phone calls and music while in the vehicle. In active noise control techniques, systems which include a reference microphone which picks up noise, an error microphone which picks up sound at a user's position, a noise suppression device which generates an erasure sound signal for eliminating noise from a noise signal which is an output of the reference microphone and an error signal which is an output of the error microphone, and a speaker which emits sound based on an erasure sound signal (hereafter referred to as “erasure sound”) are commonly used (refer to NPL 1). In this system, the operation of determining what kind of erasure sound needs to be emitted from the speaker to suppress noise is repeatedly performed while measuring how much the noise picked up by the reference microphone is suppressed by an error microphone installed near the user.

### CITATION LIST

### Non Patent Literature

[NPL 1] Yoshinobu KAJIKAWA, “Recent Topics and Applications of Active Noise Control,” IPSJ Research Report, Vol. 2015-MUS-107, No. 3, pp. 1-6, 2015.

### SUMMARY OF INVENTION

### Technical Problem

However, in the system described above, the filter coefficients calculated using the noise signal and the error signal are used for generating the erasure sound signal. Thus, for example, if sound other than noise which is expected to occur around the user, such as sound with an excessive volume or sound that fluctuates over time is input to the reference microphone or the error microphone, there is a problem that the filter coefficients cannot be calculated appropriately and the operation of the system becomes unstable.

Therefore, an object of the present invention is to provide a noise suppression technique which operates stably even when a reference microphone or an error microphone picks up sounds other than noise expected to occur around a user.

### Solution to Problem

An aspect of the present invention suppresses a noise suppression function for sounds other than noise expected to occur around a user (hereinafter referred to as “unexpected sounds”).

### Advantageous Effects of Invention

According to the present invention, a noise suppression function can stably operate even when a reference microphone or an error microphone picks up sounds other than noise expected to occur around a user.

### BRIEF DESCRIPTION OF DRAWINGS

FIG. 1 is a block diagram showing a configuration of a noise suppression device 100.

FIG. 2 is a flowchart for describing an operation of the noise suppression device 100.

FIG. 3 is a block diagram showing a configuration of a noise suppression device 200.

FIG. 4 is a flowchart for describing an operation of the noise suppression device 200.

FIG. 5 is a diagram showing how microphones are installed.

FIG. 6 is a diagram showing an example of a functional configuration of a computer which implements each device in an embodiment of the present invention.

### DESCRIPTION OF EMBODIMENTS

Embodiments of the present invention will be described in detail below. Note that constituent elements having the same function will be denoted by the same reference numerals and redundant description thereof will be omitted.

### first embodiment

A noise suppression device 100 stably operates a noise suppression function by suppressing the noise suppression function for sounds other than noise expected to occur around a user (hereinafter referred to as “unexpected sound”). Here, noise expected to occur around the user is referred to as, for example, sounds which come from the outside of a preset area such as train running sounds and sounds outside the train in the case of a noise suppression function used inside a train, and for example, sound that is stationary and has predetermined statistical characteristics so that the band can be predicted to some extent. Also, unexpected sounds are sounds which come from within a preset area such as the sound of clothes rubbing against a microphone or the voices of passengers on a train or sounds which deviate from preset statistical characteristics.

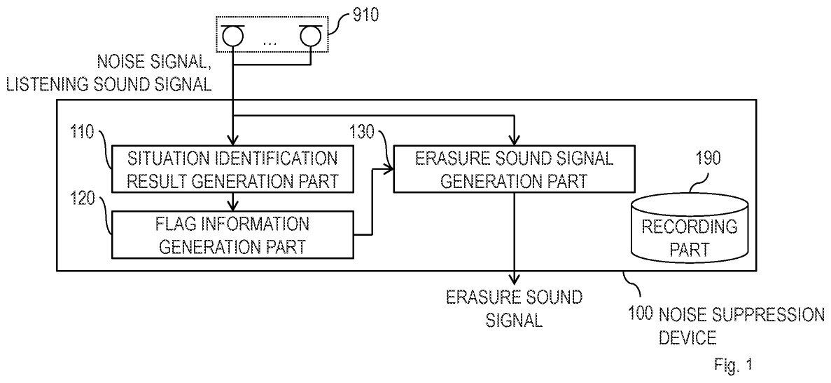

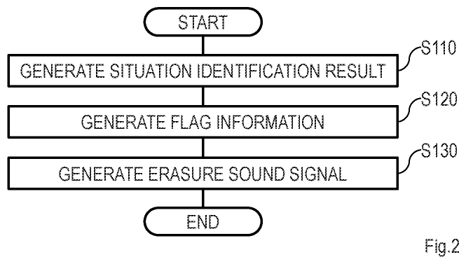

The noise suppression device 100 will be described below with reference to FIGS. 1 and 2. FIG. 1 is a block diagram showing a configuration of the noise suppression device 100. FIG. 2 is a flowchart for describing an operation of the noise suppression device 100. As shown in FIG. 1, the noise suppression device 100 includes a situation identification result generation part 110, a flag information generation part 120, an erasure sound signal generation part 130, and a recording part 190. The recording part 190 is a component which appropriately records information necessary for processing of the noise suppression device 100.

The noise suppression device 100 connects one or more microphones 910 (hereinafter referred to as “reference microphones”) to acquire the noise around the user and one or more microphones 910 (hereinafter referred to as “error microphones”) to acquire the sound heard by the user. Also, the noise suppression device 100 is connected to one or more speakers (not shown) to emit a sound based on the erasure sound signal, that is, the erasure sound.

The operation of the noise suppression device 100 will be described according to FIG. 2.

In S110, the situation identification result generation part 110 receives, as inputs, at least one signal (hereinafter referred to as an “input signal”) of signals of noise around the user acquired using one or more microphones (hereinafter referred to as “noise signals”) and signals of the user's listening sound acquired using one or more microphones (hereinafter referred to as “listening sound signals”) and generates and outputs a situation identification result indicating whether unexpected sound is generated for each input signal. The situation identification result generation part 110 may generates a situation identification result indicating that unexpected sound has occurred, for example, when the power of the input signal is greater than a predetermined threshold value or it is greater than or equal to the predetermined threshold value, and, in other cases, the situation identification result generation part 110 generates a situation identification result indicating that unexpected sound has not occurred. The situation identification result generation part 110 generates a situation identification result indicating that an unexpected sound occurs, for example, when the temporal change in the power of the input signal is greater than a predetermined threshold value or it is greater than or equal to the predetermined threshold value, and, in other cases, the situation identification result generation part 110 generates a situation identification result indicating that an unexpected sound does not occur. The situation identification result generation part 110 generates a situation identification result indicating that an unexpected sound occurs, for example, when the power distance between the frequency spectrum of the input signal and the spectrum of the assumed noise is greater than a predetermined threshold value or it is greater than or equal to the predetermined threshold value, and, in other cases, the situation identification result generation part 110 generates a situation identification result indicating that an unexpected sound does not occur. That is to say, when it is determined that the input signal is not the noise expected to occur around the user on the basis of the statistical properties of the input signal, the situation identification result generation part 110 generates a situation identification result indicating that an unexpected sound occurs.

In S120, the flag information generation part 120 receives, as an input, the situation identification result generated in S110 and generates and outputs flag information indicating whether to generate a signal for erasure sound for erasing noise around the user (hereinafter referred to as an erasure sound signal) from the situation identification result. For example, when there are two or more situation identification results generated in S110, the flag information generation part 120 generates flag information indicating not to generate an erasure sound signal when at least one situation identification result indicates that an unexpected sound occurs, and, in other cases, the flag information generation part 120 generates flag information indicating generation of an erasure sound signal.

In S130, an erasure sound signal generation part 130 receives, as inputs, the noise signal and the listening sound signal, does not generate an erasure sound signal when the flag information indicates not to generate an erasure sound signal, and generates and outputs an erasure sound signal from the noise signal and the listening sound signal in other cases. The erasure sound signal generation part 130 may generate an erasure sound signal using an adaptive filter generated using a well-known adaptive algorithm. The speaker receives the erasure sound signal generated in S130 and emits sound based on the erasure sound signal.

That is to say, the noise suppression device 100 suppresses the noise suppression function (more precisely, the noise suppression function does not operate) by not generating an erasure sound signal in a predetermined case.

According to the embodiment of the present invention, even when the reference microphone or the error microphone picks up sounds other than the noise expected to occur around the user, the noise suppression function can operate stably.

### Second Embodiment

As in the noise suppression device 100, the noise suppression device 200 stably operates the noise suppression function by suppressing the noise suppression function for sounds other than noise expected to occur around the user (hereinafter referred to as “unexpected sound”).

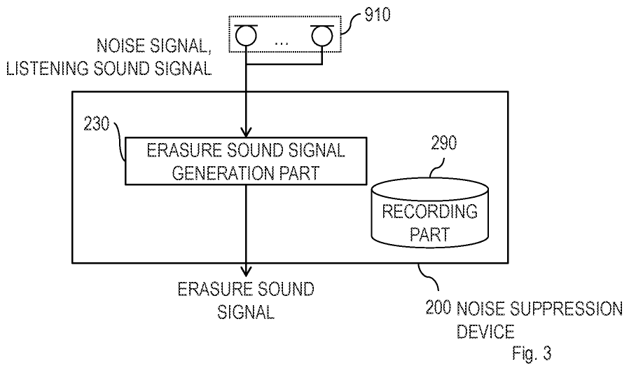

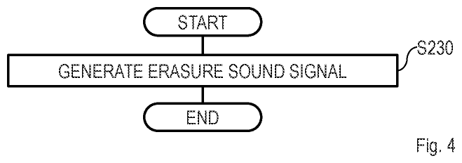

The noise suppression device 200 will be described below with reference to FIGS. 3 and 4. FIG. 3 is a block diagram showing a configuration of the noise suppression device 200. FIG. 4 is a flowchart for describing an operation of the noise suppression device 200. As shown in FIG. 3, the noise suppression device 200 includes an erasure sound signal generation part 230 and a recording part 290. The recording part 290 is a component which appropriately records information necessary for processing of the noise suppression device 200.

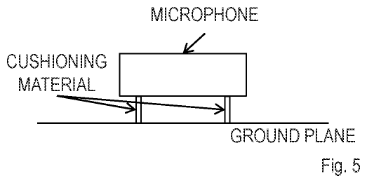

The noise suppression device 200 uses one or more microphones 910 (hereinafter referred to as “reference microphones”) to acquire noise around the user and one or more microphones 910 (hereinafter referred to as “error microphones”) to acquire the sound heard by the user. As illustrated in FIG. 5, a microphone 910 is installed using a predetermined member so that a gap is formed between it and the ground plane. Here, the predetermined member is, for example, a cushioning material which absorbs vibration and any member which can create a gap between the microphone 910 and the ground plane can be used. The microphone 910 does not pick up an unexpected sound such as an extremely loud sound by setting the microphone 910 as illustrated in FIG. 5. Also, the noise suppression device 200 is connected to one or more speakers (not shown) to emit a sound based on the erasure sound signal, that is, the erasure sound.

An operation of the noise suppression device 200 will be described according to FIG. 4.

In S230, the erasure sound signal generation part 230 receives, as inputs, signals of noise around the user acquired using one or more microphones 910 (hereinafter referred to as “noise signals”) and signals of the user's listening sound acquired using one or more microphones 910 (hereinafter referred to as “listening sound signals”) and generates and outputs a signal for erasure sound for erasing noise around the user (hereinafter referred to as an “erasure sound signal”) from the noise signals and the listening sound signals. The erasure sound signal generation part 230 may generate an erasure sound signal using an adaptive filter generated using a well-known adaptive algorithm. The speaker receives the erasure sound signal generated in S230 and emits sound based on the erasure sound signal.

That is to say, the noise suppression device 200 suppresses the noise suppression function by setting a microphone 910 in a predetermined manner and suppressing the sound pickup function of the microphone 910.

Note that the installation method of the microphone 910 described in this embodiment may be applied to the first embodiment. That is to say, the microphone 910 may be installed in the noise suppression device 100 using a predetermined member so that a gap is formed between it and the ground plane.

According to the embodiment of the present invention, even when the reference microphone or the error microphone picks up sounds other than the noise expected to occur around the user, the noise suppression function can operate stably.

### Additional Note

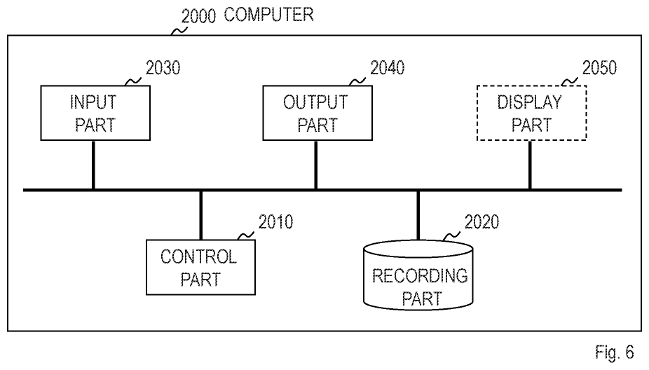

FIG. 6 is a diagram showing an example of a functional configuration of a computer 2000 which implements each device described above. The processing in each device described above can be performed by causing the recording part 2020 to read a program for causing the computer 2000 to function as each device described above and causing a control part 2010, an input part 2030, an output part 2040, and the like to operate.

The device of the present invention includes, for example, as a single hardware entity, an input part to which a keyboard or the like can be connected, an output part to which a liquid crystal display can be connected, a communication part which can be connected by a communication device (for example, a communication cable) capable of communicating externally with a hardware entity, a CPU (Central Processing Unit: which may include a cache memory, a register, and the like), a RAM and a ROM which are memories, an external storage device such as a hard disk, and a bus which connects these input parts, output parts, communication parts, CPU, RAM, ROM, and external storage devices so that data can be exchanged. Also, if necessary, the hardware entity may include a device (drive) capable of reading and writing a recording medium such as a CD-ROM. A physical entity with such hardware resources includes a general purpose computer.

The external storage device of the hardware entity stores programs necessary for realizing the functions described above, data necessary for processing the programs, and the like (not limited to the external storage device, for example, the program may be stored in a ROM which is a read-only storage device). In addition, the data obtained by the processing of these programs are appropriately stored in a RAM, an external storage device, or the like.

In the hardware entity, each program stored in an external storage device (or a ROM or the like) and the data necessary for processing each program are read into a memory as needed, and interpreted, executed, and processed by the CPU as appropriate. As a result, the CPU realizes a predetermined function (each component represented by the above, . . . part, . . . means, and the like).

The present invention is not limited to the above-described embodiments, and can be modified as appropriate without departing from the scope of the present invention. Furthermore, the processes described in the above embodiments are not only executed in chronological order according to the described order, but may also be executed in parallel or individually according to the processing capacity of the device which executes the processes or as necessary.

As described above, when the processing functions of the hardware entity (devices of the present invention) described in the above embodiments are implemented by a computer, the processing contents of the functions that the hardware entity needs to have are described by a program. The processing functions of the hardware entity are realized on the computer by executing this program on a computer.

A program describing the contents of this processing can be recorded in a computer-readable recording medium. Any computer-readable recording medium may be used, for example, a magnetic recording device, an optical disk, a magneto-optical recording medium, a semiconductor memory, or the like. Specifically, for example, as magnetic recording devices, a hard disk device, a flexible disk, a magnetic tape, and the like can be used, as optical discs, a DVD (Digital Versatile Disc), a DVD-RAM (Random Access Memory), a CD-ROM (Compact Disc Read Only Memory), a CD-R (Recordable)/RW (ReWritable), and the like can be used, as magneto-optical recording media, an MO (Magneto-Optical disc), and the like can be used, and as semiconductor memories, an EEP-ROM (Electronically Erasable and Programmable-Read Only Memory) and the like can be used.

Also, distribution of this program is carried out by selling, assigning, lending, etc. portable recording media such as DVDs and CD-ROMs on which the program is recorded, for example. Furthermore, the program may be distributed by storing the program in the storage device of the server computer and transferring the program from the server computer to other computers via the network.

A computer which executes such a program, for example, first stores the program recorded on a portable recording medium or the program transferred from the server computer once in an own storage device thereof. When executing the process, this computer reads the program stored in an own storage device thereof and executes the process according to the read program. Furthermore, as another execution form of this program, the computer may directly read the program from a portable recording medium and execute processing according to the program. In addition, each time the program is transferred from the server computer to this computer, the process according to the received program may be sequentially executed. In addition, the above processing is executed by a so-called ASP (Application Service Provider) type service which does not transfer the program from the server computer to this computer and realizes the processing function only by the execution instruction and result acquisition. Note that the program in this embodiment includes information to be used for processing by a computer and equivalent to a program (data that is not a direct command to the computer but has the property of prescribing the processing of the computer or the like).

Moreover, in this embodiment, the hardware entity is configured by executing a predetermined program on the computer, but at least part of these processing contents may be implemented by hardware.

The foregoing descriptions of embodiments of the invention have been presented for purposes of illustration and description. It is not intended to be exhaustive or to limit the invention to the precise forms disclosed. Modifications and variations are possible in light of the above teachings. The embodiments have been chosen and expressed to provide the best illustration of the principles of the invention and to enable those skilled in the art to utilize the present invention in various embodiments and with various modifications as suitable for the practical use contemplated. All such modifications and variations are within the scope of the present invention as defined by the appended claims, construed in accordance with their breadth which is fairly and legally afforded.

1. A noise suppression device, in which a noise suppression function for sounds other than noise expected to occur around a user (hereafter referred to as “unexpected sounds”) is suppressed.

2. The noise suppression device according to claim 1, comprising:
a situation identification result generation circuitry which, using at least one signal of a signal of noise around the user acquired using one or more microphones (hereinafter referred to as a “noise signal”) and a signal of the user's listening sound acquired using one or more microphones (hereinafter referred to as a “listening sound signal”), generates a situation identification result indicating whether an unexpected sound occurs for each of the signals;
a flag information generation circuitry which generates flag information indicating whether to generate a signal for erasure sound for erasing noise around the user (hereinafter referred to as an “erasure sound signal”) from the situation identification result; and
an erasure sound signal generation circuitry which, when the flag information indicates not to generate an erasure sound signal, does not generate the erasure sound signal and, in other cases, generates the erasure sound signal from the noise signal and the listening sound signal.

3. The noise suppression device according to claim 2, wherein
the flag information generation circuitry generates,
when there are two or more of the situation identification results, flag information indicating not to generate an erasure sound signal when at least one situation identification result indicates that an unexpected sound occurs.

4. The noise suppression device according to claim 2, wherein
the microphones are installed using a predetermined member so that a gap is formed between it and the ground plane.

5. The noise suppression device according to claim 1, comprising
an erasure sound signal generation circuitry which generates a signal for erasure sound for erasing noise around the user (hereinafter referred to as an “erasure sound signal”) from a signal of noise around the user acquired using one or more microphones (hereinafter referred to as a “noise signal”) and a signal of the user's listening sound acquired using one or more microphones (hereinafter referred to as a “listening sound signal”),
wherein the microphones are installed using a predetermined member so that a gap is formed between it and the ground plane.

6. A noise suppression method, in which a noise suppression device suppresses a noise suppression function for sounds other than noise expected to occur around a user (hereinafter referred to as “unexpected sounds”).

7. A non-transitory computer-readable storage medium which stores a program for causing a computer to function as the noise suppression device according to claim 1.
